(19) United States
(12) Patent Application Publication
(10) Pub. No.: US 2017/0050521 A1
(43) Pub. Date: Feb. 23, 2017

(54) DATA TRANSFERRING SYSTEM FOR A VEHICLE

(71) Applicant: Faraday&Future Inc., Gardena, CA (US)

(72) Inventor: Hamed SHAW, Sunnyvale, CA (US)

(73) Assignee: Faraday&Future Inc., Gardena, CA (US)

(21) Appl. No.: 14/860,655

(22) Filed: Sep. 21, 2015

Related U.S. Application Data
(60) Provisional application No. 62/207,332, filed on Aug. 19, 2015.

(51) Int. Cl. B60K 35/00; G06F 3/048

(52) U.S. Cl. CPC B60K 35/00; G06F 3/048; B60K 2350/352; B60K 2350/357; B60K 2350/2052; B60K 2350/901; B60K 2350/1076; B60K 2350/1096; B60K 2350/928; B60K 2350/1044

(57) ABSTRACT

A control system for a vehicle for transferring data from a communication device, which may include at least one control interface configured to receive a first input from a driver and a display configured to generate an output visible to the driver. The control system may also include a controller in communication with the communication device, the at least one control interface, and the display. The controller may be configured to receive data from the communication device and generate and output a query to the display based on the data. The controller may also be configured to receive the first input from at least one control interface and output the data to the display based on the first input.

### CROSS REFERENCE TO RELATED APPLICATION

This application claims the benefit of priority based on U.S. Provisional Patent Application No. 62/207,332 filed on Aug. 19, 2015, the entire disclosure of which is incorporated by reference.

### TECHNICAL FIELD

The present disclosure relates generally to a system for a vehicle and, more particularly, to a data transferring system for a vehicle.

### BACKGROUND

Current technology allows people to send and receive information almost instantaneously. For example, mobile communication devices allow users to send emails, text messages, images, websites, and even videos between users in milliseconds. Mobile communication devices also allow users to navigate the world by providing directions, traffic information, and satellite imaging. This interaction with mobile communication devices has connected people in a way that has changed many lives.

However, the use of mobile communication devices while driving a vehicle may be dangerous because it requires the driver to take his/her hands off of the steering wheel and divert his/her eyes from the road. This is especially concerning because some mobile applications (e.g., turn-by-turn directions) are specifically designed to provide information to people while they are driving. Some vehicles have built-in user interfaces that may reduce the distraction to the driver by providing audio directions. However, the built-in user interfaces of the current technology have limited interactions with other communication devices.

The data transferring system of the present disclosure may mitigate or solve one or more of the problems set forth above and/or other problems in the art.

### SUMMARY

One aspect of the present disclosure is directed to a control system for a vehicle for transferring data from a communication device. The control system may include at least one control interface configured to receive a first input from a driver or another vehicle occupant, and a display configured to generate an output visible to the driver or another vehicle occupant. The control system may also include a controller in communication with the communication device, the at least one control interface, and the display. The controller may be configured to receive data from the communication device, and generate and output a query to the display based on the data. The controller may also be configured to receive the first input from the at least one control interface, and output the data to the display based on the first input.

Another aspect of the present disclosure is directed to a method of transferring data from a communication device to a vehicle. The method may include receiving data from the communication device, and generating and outputting a query to a display based on the data. The method may also include receiving a first input from at least one control interface, and outputting the data to the display based on the first input.

Yet another aspect of the present disclosure is directed to a vehicle. The vehicle may include a driver seat configured to accommodate a driver, and a control system for transferring data from a communication device. The control system may include at least one control interface configured to receive a first input from the driver or another vehicle occupant, and a display configured to generate an output visible to the driver or another vehicle occupant. The control system may also include a controller in communication with the communication device, the at least one control interface, and the display. The controller may be configured to receive data from the communication device, and generate and output a query to the display based on the data. The controller may also be configured to receive the first input from the at least one control interface, and output the data to the display based on the first input.

Still another aspect of the present disclosure is directed to a non-transitory computer-readable medium storing instructions which, when executed, cause one or more processors to perform a method of transferring data from a communication device. The method may include receiving data from the communication device in a controller, and generating and outputting a query to a display based on the data. The method may also include receiving a first input from at least one control interface, and outputting the data to the display based on the first input.

### BRIEF DESCRIPTION OF THE DRAWINGS

FIG. 1 is a diagrammatic illustration of an exemplary disclosed control panel;

FIG. 2 is a block diagram of an exemplary control system that may be used with the control panel of FIG. 1, according to an exemplary embodiment of the disclosure;

FIG. 3 is a flowchart illustrating a first exemplary process that may be performed by the control system of FIG. 2, according to an exemplary embodiment of the disclosure; and

FIG. 4 is a flowchart illustrating a second exemplary process that may be performed by the control system of FIG. 2, according to an exemplary embodiment of the disclosure.

### DETAILED DESCRIPTION

The disclosure is generally directed to a system and method of transferring data from a communication device to a vehicle. The system may be implemented when a driver or a vehicle receives routing or other data from a communication, such as a text message, an email, an instant message, a smart phone app, or a telephone call. A query may then be displayed to a driver in a head-up display (HUD), and a control interface may provide the driver a number of data management options. If accepted, the full data may be displayed in the HUD.

Another aspect of the disclosure is directed to a system and a method of transferring data to a person after exiting the vehicle. For example, the transfer may be applicable when he/she exits the vehicle a distance from his/her ultimate destination and walks the remaining distance. The vehicle may be configured to determine that he/she has exited the vehicle and is currently walking to the destination. The vehicle may then send a query to determine if he/she chooses to accept the data. Upon acceptance, the vehicle may change the form of the data (e.g., to walking directions) and send the data to his/her mobile communication device.

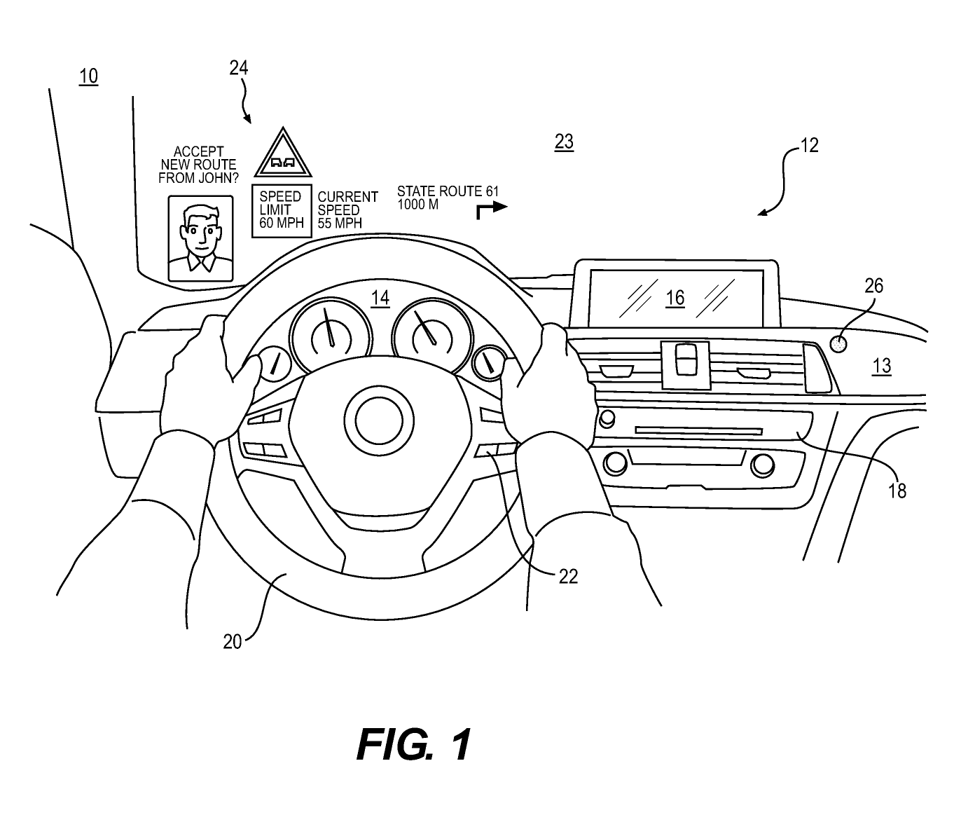

FIG. 1 illustrates an exemplary control panel 12 of an exemplary vehicle 10. As illustrated in FIG. 1, control panel 12 may include among other things, a dashboard 13 that may house or embed an instrument panel 14, a user interface 16, a stereo system 18, and a microphone 26. Dashboard 13 may also be associated with a steering wheel 20 having at least one control interface 22, which may be manipulated by a driver. Vehicle 10 may also have a windshield 23 onto which a head-up display (HUD) 24 may be projected.

HUD 24 may be pre-installed into vehicle 10, housed or embedded in dashboard 13. In another embodiment, HUD 24 may be a separate component positionable on an upper surface of dashboard 13. For example, HUD 24 may be secured with a releasable adhesive, a suction cup, or the like. HUD 24 may be positioned substantially aligned with steering wheel 20 to allow the driver to see the data without having to redirect his/her sightline.

HUD 24 may be configured to project text, graphics, and/or images onto windshield 23 to provide the driver a vast amount of information pertaining to the driver and/or vehicle 10. HUD 24 may be configured to display speed limits and turn-by-turn directions to the driver, or may be configured to warn the driver of approaching road conditions, such as construction or traffic. HUD 24 may also be configured to repeat data from at least one of instrument panel 14, user interface 16, and stereo system 18. For example, HUD 24 may be configured to display the speed of vehicle 10 to the driver. HUD 24 may be configured to display other conditions of vehicle 10, such as battery level, fuel level, water level, and engine speed. HUD 24 may also be configured to allow access to stereo system 18 without the driver having to redirect his/or her vision. For example, HUD 24 may be configured to provide the driver with information, such as the current song title and radio station. HUD 24 may be further configured to display to the driver whether any of the doors of vehicle 10 are ajar. Furthermore, HUD 24 may be configured to connect to devices positioned either remotely or within a close proximity to (e.g., within) the vehicle 10, as later discussed in more detail.

Control interface 22 may be conveniently positioned on steering wheel 23 to allow the driver to provide input with minimal distraction. Control interface 22 may include one or more buttons configured to provide input to a variety of functions of vehicle 10. Control interface 22, additionally or alternatively, may include one or more touchpads with different portions to control each function of vehicle 10.

Control interface 22 may be configured to allow the driver to manipulate HUD 24. In one embodiment, control interface 22 may be configured to allow the driver to toggle through the data displayed in HUD 24. For example, control interface 22 may be configured to allow the driver to toggle through turn-by-turn directions of different routes, and display different portions of the available routes. Control interface 22 may also be configured to allow the driver to actuate other components of vehicle 10 via data displayed on HUD 24. For example, control interface 22 may be configured to allow the driver to change the audio output of stereo system 18, or manipulate a cruise control system of vehicle 10. Furthermore, control interface 22 may be configured to provide the driver data managements options (e.g., to accept, to reject, or to save) for data that vehicle 10 may receive. For example, in one embodiment, control interface 22 may have a separate button designated for each of the data management options. In another embodiment, control interface 22 has one button that allows the driver to toggle through the data management options. Control interface 22 may also allow the driver to access data through HUD 24, which has been saved for recall.

Microphone 26 may include any structure configured to capture audio and generate audio signals of interior of vehicle 10. As depicted in FIG. 1, microphone 26 may be centrally located on dashboard 13 to capture audio and may be configured to capture voice commands from the driver in order to control functions of vehicle 10. Microphone 26 may also allow the driver to respond to messages that they receive through HUD 24. For example, microphone 26 may be configured to transmit audio for phone calls initiated through HUD 24. Microphone 26 may also be configured capture audio which may be transcribed into text messages or emails.

User interface 16 may be configured to receive input from the user and transmit media. User interface 16 may include an LCD, an LED, a plasma display, or any other type of display. User interface 16 may provide a Graphical User Interface (GUI) presented on the display for user input and data display. User interface 16 may further include a touchscreen, a keyboard, a mouse, or a tracker ball to enable user input. User interface 16 may be configured to receive user-defined settings. For example, user interface 16 may be configured to receive a driver profile, including the desired position of HUD 24. It is contemplated that user interface 16 may be disabled when vehicle 10 is in motion to reduce distraction.

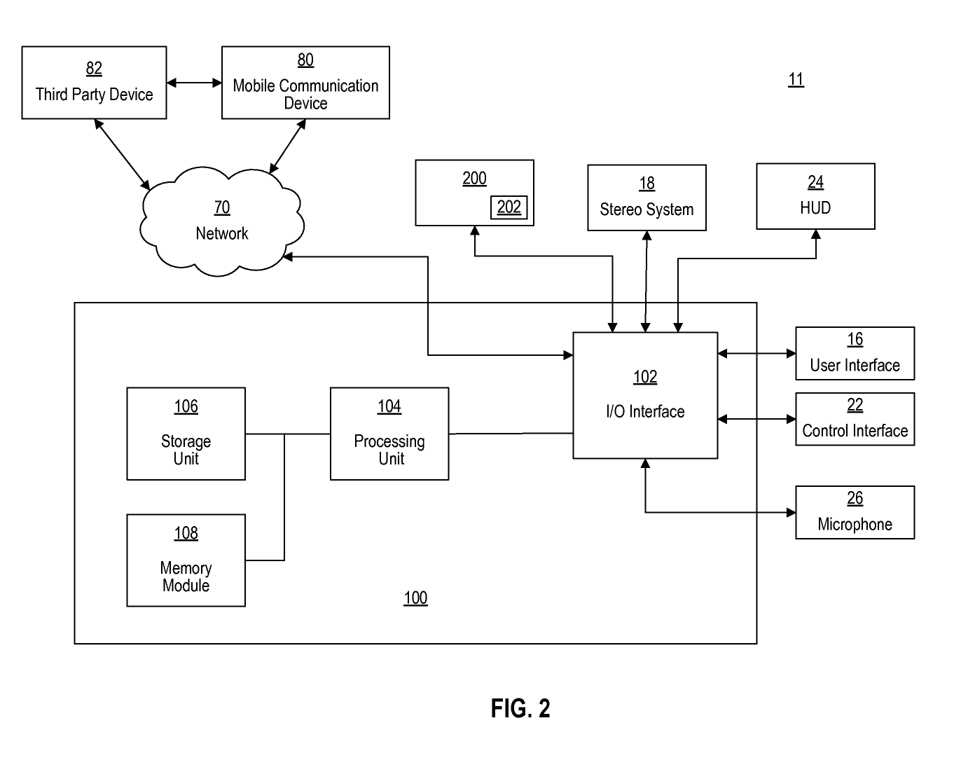

FIG. 2 provides a block diagram of an exemplary control system 11 that may be used to transfer data of vehicle 10. As illustrated in FIG. 2, control system 11 may include a controller 100 having, among other things, an I/O interface 102, a processing unit 104, a storage unit 106, and a memory module 108. One or more of the components of controller 100 may be installed in an on-board computer of vehicle 10. These components may be configured to transfer data and send or receive instructions between or among each other.

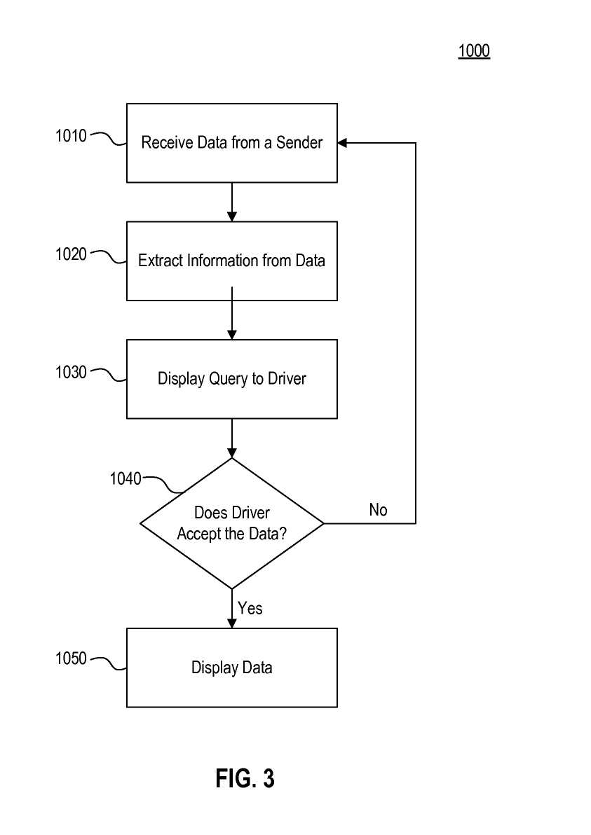

I/O interface 102 may also be configured for two-way communication between controller 100 and various components of control system 11. For example, as depicted in FIG. 3, I/O interface 102 may send and receive operating signals to and from user interface 16, stereo system 18, control interface 22, HUD 24, microphone 26, and a status sensor 202 operatively connected to a power source 200. I/O interface 102 may send and receive the data between each of the components via communication cables, wireless networks, or other communication mediums.

I/O interface 102 may be configured to consolidate signals that it receives from the various components and relay the data to processing unit 104. Processing unit 104 may include any appropriate type of general-purpose or special-purpose microprocessor, digital signal processor, or microcontroller of vehicle 10. Processing unit 104 may be configured as a separate processor module dedicated to the data transmission. Alternatively, processing unit 104 may be configured as a shared processor module for performing other functions of vehicle 10 unrelated to the data transmission.

Processing unit 104 may be configured to receive data from components of control system 11 and process the data to determine a plurality of conditions of the operation of vehicle 10. Processing unit 104 may also be configured to generate and transmit command signals, via I/O interface 102 in order to actuate the components of control system 11.

For example, processing unit 104 may be configured to remotely transmit and receive data to and from one or more communication devices, such as a mobile communication device 80 and a third party device 82, over a network 70. Network 70 may be any type of wired or wireless network that may allow transmitting and receiving data. For example, network 70 may be a nationwide cellular network, a local wireless network (e.g., Bluetooth™ or WiFi), or a wired network. Mobile communication devices 80 and/or third party device 82 may also be configured to transmit geographic positioning data over network 70 to I/O interface 102, as later discussed in detail.

Mobile communication device 80 and third party devices 82 may be any type of communication device. For example, mobile communication device 80 and/or third party device 82 may include a smart phone with computing ability, a tablet, a personal computer, a wearable device, such as a smart watch or Google Glass™, and/or complimentary components. Third party device 82 may also include a communication device of another vehicle, a public system, and/or a communication device associated with a business.

One or more mobile communication device 80 may be associated with people that are recognized by vehicle 10 (e.g., owner(s) or occupant(s)). For example, processer 104 may be configured to recognize one or more mobile communication devices 80 based on data stored in storage unit 106 and/or memory module 108. For example, the stored data may include the person's name, the person's relationship with vehicle 10, the person's contact information, and a digital signature of communication device 80. The digital signature of communication device 80 may be according to a determinative emitted radio frequency (RF) or a GPS tag. Processing unit 104 may also be configured to enable geolocation tracking software, including GPS tracking software, on mobile communication device 80. In one embodiment, one or more mobile communication devices 80 may be configured to automatically connect to controller 100 through local network 70, e.g., Bluetooth™ or WiFi, when in proximity of (e.g., within) vehicle 10.

Processing unit 104 may also be configured to connect to mobile communication devices 80 of occupants of vehicle 10 not associated with stored data. For example, controller 100 may be configured to respond to mobile communication device 80 when it accesses local network 70 or when determined, by global positioning, that mobile communication device 80 is within vehicle 10. For example, controller 100 may send a query to mobile communication device 80 to determine if the person associated with the device wants mobile communication device 80 to be recognized by vehicle 10. If so, controller 100 may be configured to download and store data pertaining to those mobile communication devices 80, such as the person's name, the person's contact information's, and the digital signature of mobile communication device 80. Controller 100 may also be configured to enable GPS tracking software on those mobile communication devices 80.

One or more mobile communication devices may be configured to automatically send and/or receive data to and from controller 100. For example, when mobile communication device 80 is within vehicle 10 and/or connected to local network 70, I/O interface 102 may initiate transfer of stored data, such as contacts, music files, applications, and/or personal information. Furthermore, controller 100 may be configured to automatically receive data that is sent to any connected mobile communication device 80. For example, when mobile communication device 80 receives data from third party devices 82, mobile communication device 80 may be configured to automatically send and receive the data to and from I/O interface 102.

Controller 100 may also be configured to send and receive data sent from mobile communication device 80 and/or third party device 82 through other types of media. For example, communications may be sent to controller 100 through a designated phone number, a website, an email address, a sms address, a twitter handle, and/or an app. For example, third party devices 82, such as businesses, may be configured to send broadcasts, emails, or sms texts to controller 100 containing information such as promotions, coupons, or directions to local stores. These communications may be enabled by the occupant(s) allowing the business to locate vehicle 10 through GPS data. Controller 100 may also request other information from third party devices 82, such as traffic conditions from public systems. After receipt of any data, controller may be configured to process the data.

For example, processing unit 104 may be configured to extract metadata, such as the name of the sender, the time it was received, the type of data, and/or the means that the data was received. Processing unit 104 may also be configured to execute optical character recognition software (OCR) to extract information, such as names, dates, and/or other words from received data in text form. Processing unit 104, executing OCR, may be configured to determine the frequency of words and/or the tone of the text. Processing unit 104 may further be configured to extract information from received directions such as the destination and/or the estimated length of the trip. It is contemplated that processing unit 104 may be configured to recalculate the directions based on the current location of vehicle 10 and/or mobile communication device 80. It is further contemplated that processing unit 104 may be configured to store the received and/or extracted data in storage unit 106 and/or memory module 108.

Processing unit 104 may be configured to gather and analyze other data pertaining to the received and/or extracted data that may be stored in controller 100 and/or mobile communication device 80. For example, processing unit 104 may be configured to gather stored profiles of the sender including images and/or other data sent from the sender. Processing unit 104 may also be configured to organize and group data based on information, such as the sender or content. When the data is in the form of directions, processing unit 104 may be configured to gather alternative directions to the same destination. Processing unit 104 may then be configured to determine information such as relative distance, relative time, and/or relative traffic of the received directions compared to the other known directions to the same destination. The stored data of mobile communication device 80, storage unit 106, and/or memory module 108 may be updated based on the received and/or extracted data.

Processing unit 104 may also be configured to display data through user interface 16 and/or HUD 24. In some embodiments, processing unit 104 may be configured to display queries, without necessarily displaying the entire data. The query may include text, graphics, and/or images providing information extracted from the received data. The query may prompt the occupant to provide an input pertaining to data management. In some embodiments, processing unit 104 may be configured to display portions of the data and/or metadata via HUD 24 to determine if the driver wants the data, as a whole, to be displayed. For example, the query may display the source of the data, a brief description of the data, a portion of the data, and/or the type of data. The query may be substantially smaller in size than the entire data. For example, the query may include a limited word or character counts (e.g., about 10-20 words or about 100-150 characters). It is also contemplated that the query may display information from stored profiles of the sender, such as images and/or names (e.g., first names, full names, and/or saved nicknames).

Processing unit 104 may also be configured to receive an input from occupants of vehicle 10 indicative of data management and process the data accordingly. Processing unit 104 may have any number of data management options, such as accept, reject, save, delete, modify, display later, hold, transfer, pause, forward, or reply, which may be entered through at least one of user interface 16, control interface 22, and/or microphone 26. If the occupant accepts the data, processing unit 104 may be configured to display the data, as a whole, in a number of different ways. For example, if the driver accepts directions from the sender, the turn-by-turn directions may be fully displayed through HUD 24. If the data includes audio, processing unit 104 may be configured to transmit the audio files (e.g., music files) to stereo system 18. If rejected, controller 100 and/or mobile communication device 80 may be configured to not display the data. In some embodiments, controller 100 may also be configured to automatically delete any rejected data from storage unit 106, memory module 108, and/or mobile communication device 80. This may advantageously reduce the cumbersome accumulation of data. On the other hand, if the occupant chooses to save the data, processing unit 104 may be configured to store the data in storage unit 106 and/or memory module 108, such that the data may be accessible by the occupant for later display. If the occupant chooses to display the data later, processing unit 104 may be configured to automatically display the data at a certain time point. Furthermore, if the occupant chooses to forward the data or reply to the sender, processing unit 104 may be configured to generate and transmit a communication over network 70.

Controller 100 may be configured to display data through at least one of user interface 16, HUD 24, and/or stereo system 18 based on the operation of vehicle 10. For example, controller 100 may be configured to display data to HUD 24 and/or stereo system 18 when vehicle 10 is in motion (e.g., in a forward or a reverse gear) in order to minimize distraction. When stopped (e.g., in park), vehicle may be configured to display data in user interface 16, HUD 24, and/or stereo system 18.

According to some embodiments, processing unit 104 may be configured to transfer data to mobile communication device 80 based on a change in status of a recipient. In one embodiment, processing unit 104 may be configured to determine whether one or more people have exited vehicle 10 by tracking mobile communication device 80. This determination may be performed continuously, intermittently, and/or based on a sufficient condition of vehicle 10.

For example, status sensor 202 may be operatively connected to vehicle 10 and configured to generate a signal to determine when a sufficient condition occurs to enable the data transfer. The sufficient condition may be based on a number of different parameters related to vehicle 10. For example, status sensor 202 may be operatively connected to power source 200, embodying at least one of an electric motor, a combustion engine, and/or a battery. In one embodiment, status sensor 202 may be configured to generate a signal to controller 100 when vehicle 10 slows down or stops. In another embodiment, status sensor 202 may be operatively connected to a transmission and configured to generate a signal when the transmission is shifted into park. In yet another embodiment, status sensor 202 may be operatively connected to a door of vehicle 10, and may be configured to generate a signal to controller 100 when the door opens and/or closes. It is contemplated that the control system 11 may allow the driver to determine what constitutes a sufficient condition, and to adjust the configuration based on stored settings.

Processing unit 104 may be configured to determine whether the person has exited vehicle 10. For example, processing unit 104 may be configured to determine the location of mobile communication device 80 and generate a command signal when mobile communication device 80 travels a certain distance from vehicle 10. In some embodiments, the determination may be based on satellite GPS tracking of mobile communication device 80. For example, processing unit 104 may be configured to utilize GPS software to receive and record locations of mobile communication device 80. Processing unit 104 may also be configured to compare the GPS locations of mobile communication device 80 to GPS locations of vehicle 10 to determine any separation. In some embodiments, processing unit 104 may be configured to make the determination based on when mobile communication device 80 is out of reach of local network 70, such as Bluetooth™ or WiFi. For example, when mobile communication device 80 is no longer connected to local network 70, processing unit 104 may be configured to generate a command signal. In yet another embodiment, the determination may be based on the controller 100 reception (or lack thereof) of an RF signal emitted by mobile communication device 80.

If it is determined that the person has exited vehicle 10, processing unit 104 may be configured to initiate the transfer of any pending data to mobile communication device 80. Pending data may include, among other things, directions to a destination, text data, digitally encoded data and/or audio data that was being processed by vehicle 10. For example, the determination of whether directions are still pending may be any directions that were being currently displayed at the time. In some embodiments, the determination may be based on whether the GPS position of vehicle 10 was positioned further than a threshold distance from the destination when the person exits the vehicle. The determination of whether the audio data is still pending may be based on whether an audio file or collection of audio files was still playing. For example, the pending audio data may include songs, podcasts, or albums that were playing when the person exits the vehicle. The pending audio data may also include signals (e.g., AM, FM, and/or XM radio stations) that stereo system 18 was receiving when the person exits the vehicle. It is also contemplated that the data transfer may be, additionally or alternatively, based on an input (e.g., pressing a button) through user interface 16, control interface 22, and/or microphone 26. For example, a person may initiate a transfer of the data to mobile communication device 80 prior to exiting vehicle 10.

In one embodiment, processing unit 104 may initiate a query to mobile communication device 80 to determine if the person desires the pending data to be transferred. For example, the query may be in the form of a notification on mobile communication device 80, and may prompt an input from the person, such as accept or reject. The notification may be a pop-up window and may be accompanied by an audible output or vibrations generated by mobile communication device 80. If user enters an input to accept the data, then processing unit 104 may be configured to transfer the data to mobile communication device 80.

Processing unit 104 may also be configured to determine the current status of the previous occupant and modify the data prior to transferring. For example, processing unit 10 may be configured to determine a current position or a current mode of transportation of the person. Processing unit 104 may determine a current speed of mobile communication device 80 based on global positioning data. Depending on the determined speed, processing unit 104 may be configured to determine that the person is stationary, walking, biking, or riding in another vehicle. Processing unit 104 may then be further configured to modify the directions based on the current position of the person and the determined mode of transportation. For example, processing unit 104 may be configured to recalculate the directions to the destination based on the current position of the person. Processing unit 104 may also be configured to change the directions to walking directions if it is determined that the person is currently walking to the destination.

Storage unit 106 and memory module 108 may include any appropriate type of mass storage provided to store any type of information that processing unit 104 may need to operate. For example, storage unit 106 may include one or more hard disk devices, optical disk devices, or other storage devices to provide storage space. Memory module 108 may include one or more memory devices including, but not limited to, a ROM, a flash memory, a dynamic RAM, and a static RAM.

Storage unit 106 and/or memory module 108 may be configured to store one or more computer programs that may be executed by controller 100 to perform functions related to the data transferring. For example, storage unit 106 and/or memory module 108 may include optical character recognition software and software configured to track the geolocation data of mobile communication devices 80. Storage unit 106 and/or memory module 108 may be further configured to store information used by processing unit 104. For example, storage unit 106 and/or memory module may include data obtained from mobile communication devices 80, such as personal profiles, personal contacts, user-input settings, and/or previous communications. Storage unit 106 and/or memory module 108 may be further configured to store algorithms and/or look-up tables for performing the functions. For example, algorithms and/or look-up tables may be utilized to analyze geolocation data to determine whether the person is stationary, walking, biking, or riding in another vehicle.

FIG. 3 illustrates a first exemplary data transferring method 1000 performed by control system 11. The disclosed control system 11 may be used on any vehicle 10 that may be configured to transfer data. By selectively displaying data to a driver in a minimally distracting manner, control system 11 may be configured to allow the driver to maintain his/her attention on operating vehicle 10. Additionally, allowing the driver to reject the data, control system 11 may reduce the load and storage requirements of controller 100. An exemplary process of exemplary control system 11 will now be described with respect to FIG. 3.

In Step 1010, controller 100 may receive a communication from a sender with incorporated data. The data may be in a variety of forms recognizable by controller 100. For example, the communication may be in the form of an email sent from third party device 82 to mobile communication 80 in the driver's possession. Mobile communication device 80 may be connected to controller 100 through a local network 70, such as Bluetooth™, such that the email is automatically transmitted from mobile communication device 80 to controller 100. Alternatively, the message may be sent from third party device 82 directly to controller 100 via network 70. For instance, the message may be sent to controller 100 via a designated email address, through a mobile application, or through a designated telephone number. It is also contemplated that the communication may be in the form of broadcasts from other third party devices, such as public systems or local businesses. For example, public systems, such as traffic broadcasts, may send the message to inform the driver of an upcoming accident or general traffic, including suggested detours. Businesses may also send information to controller 100, such as retail information and/or directions. For example, local businesses may be configured to send coupons and/or directions to businesses to controller 100 for marketing purposes. After receipt of any data from the sender, controller may process the data.

In Step 1020, controller 100 may process the data by extracting information from the received data. Controller 100 may extract metadata, such as the sender, the time it was received, the type of data, and/or the means that the data was received. Controller 100, may also execute OCR to extract text from the data. For example, controller may extract dates, names, or word(s), such as “urgent.” Controller 100 may also gather and analyze other data pertaining to the received and/or extracted data that is in storage unit 106, memory module 108, and/or mobile communication device 80. For example, controller 100 may tag and/or group related communications, such as emails in an email chain or emails with related subjects. In one embodiment, controller 100 may determine members of a class of senders (e.g., a family) based on stored data, and tag and/or group the communications based on the class of senders.

In Step 1030, one or more components of control system 11 may generate and display a query to the driver in a minimally distracting manner, such as through HUD 24. For example, for messages including text, the query may include information such as the sender, important word(s), and/or name(s) found in the text. An exemplary query for text messages or emails may include “URGENT MESSAGE FROM SHARON ABOUT MICHAEL.” An exemplary query may also include a portion of the text, such as the first 10-20 words of an email. For received directions, the query may include identification of the sender, the destination, and/or the length of time for the trip. For example, the query may include text such as “ACCEPT NEW ROUTE FROM JOHN TO WILLIAMSBURG?” accompanied with an image of the sender to promote recognition of the sender. The query may also display comparative information to other known directions, such as displaying the relative distance, relative time, and/or relative traffic delays of the received directions compared to the other known directions to the same destination. The query may display whether the communication is from a public system or business. The query may also display any tags and/or groups to which the communication may belong. For example, the query may be color-coded based on whether the communication was sent from a family member or a specific person. The query may, additionally or alternatively, be transmitted in an audio format, such as verbal notifications through speakers of vehicle 10.

In Step 1040, controller 100 may receive an input from owners or other occupants of vehicle 10 indicative of data management and process the data accordingly. For example, controller 100 may receive inputs from any number of data management options, such as accept, reject, save, display later, forward, or reply. The input may be received through command signals from control interface 22 and/or voice commands via microphone 26.

In Step 1050, one or more components of control system 11 may display the data based on acceptance. For example, when vehicle 10 is in motion (e.g., in a forward or reverse gear), HUD 24 may display the data to reduce the distraction for the driver. However, when vehicle 10 is not in motion (e.g., in park), the data may be displayed in HUD 24 and/or user interface 16. The data may be displayed in its entirety at a single time or be broken into different pages for the user to toggle through. Controller 100 may also transmit accepted audio to stereo system 18, which may be outputted immediately or saved for a later period of time.

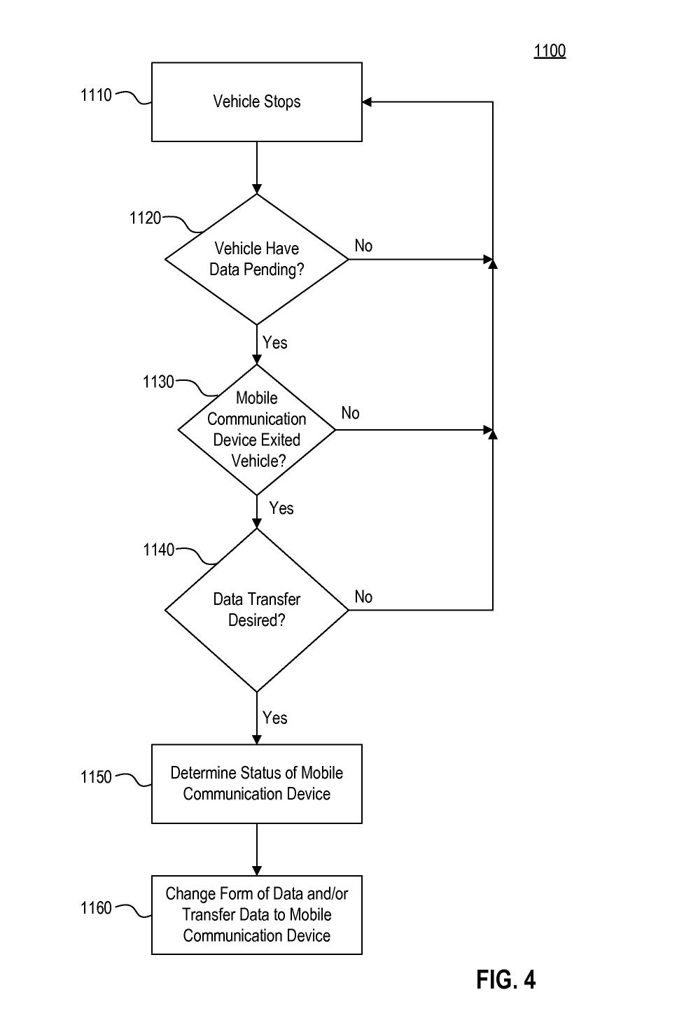

FIG. 4 illustrates a second exemplary data transferring method 1100 that may be performed by control system 11. Method 1100 may enable a seamless transfer of data for occupants when exiting a vehicle. The exemplary process of exemplary control system 11 will now be described with respect to FIG. 4.

Method 1100 may be initiated at Step 1110 according to any number of conditions of vehicle 10. In one embodiment, Step 1110 may be implemented when status sensor 202 determines that vehicle 10 sufficiently reduces speed to allow a person to exit vehicle 10. For example, Step 1110 may be initiated when status sensor 202 determines that vehicle 10 comes to a stop. In some embodiments, Step 1110 may occur when status sensor 202 determines when the transmission of vehicle 10 is shifted into park. In yet another embodiment, Step 1110 may occur when status sensor 202 determines that vehicle 10 is turned off.

In Step 1120, controller 100 may determine whether vehicle 10 has pending data. For example, the pending data may include directions being displayed in HUD 24 when vehicle 10 stops. In one embodiment, any directions that were being processed by vehicle 10 may be transferred to mobile communication device 80. In some embodiments, the determination of whether the directions are still pending may be based on calculating the distance between the stopped vehicle 10 and the ultimate destination, and comparing it to a threshold distance. If the distance is greater than the threshold distance, then controller 100 may send the directions to mobile communication device 80. Pending data may also include audio data of vehicle 10, as previously described.

In Step 1130, controller 100 may determine whether any mobile communication device 80 has exited vehicle 10. When vehicle 10 is in motion, controller 100, may continuously determine which mobile communication devices 80 are within vehicle. For example, controller 100 may determine one or more mobile communication devices 80 that are connected to local network 70 of controller 100. Controller 100 may also utilize geolocation data to determine which mobile communication devices 80 are within close proximity (e.g., within) vehicle 10. Based on the data, controller 100 may classify mobile communication devices 80 as being within vehicle. Accordingly, when vehicle 10 stops, controller 100 may determine which mobile communication devices 80 are no longer connected to controller 100 and/or no longer within close proximity of vehicle 10.

In Step 1140, controller 100 may initiate a request, via mobile communication device 80, to determine whether the data transfer is desired. The request may be in the form of a query on mobile communication device 80. The query may include text, such as “DO YOU WISH TO CONTINUE DIRECTIONS TO THE DESTINATION?” The request may additional provide prompts, such as YES, NO, and/or SAVE. If the user requests the data, controller 100 may continue to Step 1150.

In Step 1150, controller 100 may determine the status of mobile communication device 80. For example, controller 100 may determine the current location and current speed of each mobile communication device 80 determined to have exited vehicle. Based on the current location, controller 100 may recalculate the directions. Controller 100 may also alter the form of the data based on the current location of mobile communication device 80. For example, if mobile communication device 80 is sufficiently close to the destination, controller 80 may truncate the data to just the address of the destination.

Controller 100 may also determine the current mode of transportation. If the speed of mobile communication device 80 is below a threshold (e.g., about 10 MPH), controller 100 may determine that the user is walking to the destination. If the speed of mobile communication device 80 is within a range (e.g., between about 10 MPH and 20 MPH) controller 100 may determine that the user is in another mode of transportation, such as riding a bike. If the speed of mobile communication device 80 is above a threshold (e.g., about 20 MPH) controller 100 may determine that the user is traveling within another vehicle 10. The determination may, additionally or alternatively, be made according to a query sent to the user. For example, controller 100 may initiate a query, via mobile communication device 80. The query may include text, such as “DO YOU WANT TO RECEIVE WALKING DIRECTIONS?” The request may additional provide prompts, such as YES or NO. Controller 100 may accordingly determine the new form of transportation. Based on the determination of the current location and current mode of transportation, controller 100 may also suggest alternative modes of transportation. For example, controller 100 may generate a query, such as “DO YOU WISH TO TAKE PUBLIC TRANSPORTATION?” after a determination that there is a faster mode of transportation.

In Step 1160, controller 100 may change the form of the data and transfer the data to mobile communication device 80. For example, if determined that the user is walking, controller 100 may transform the driving directions to walking directions. The walking directions may be different than driving directions, in that the walking directions may ensure the safety of the user by not directing the user on non-pedestrian highways. The walking directions may also guide the user through parks or onto sidewalks which are not navigable by vehicle 10. In some embodiments, when determined that vehicle 10 is proximate to the destination, controller 100 may only send the address of the destination to the mobile communication device 80. After changing the form of the data, controller 100 may transfer the data to mobile communication device 80.

Another aspect of the disclosure is directed to a non-transitory computer-readable medium storing instructions which, when executed, cause one or more processors to perform the data transferring method, as discussed above. The computer-readable medium may include volatile or non-volatile, magnetic, semiconductor, tape, optical, removable, non-removable, or other types of computer-readable medium or computer-readable storage devices. For example, the computer-readable medium may be storage unit 106 or memory module 108 having the computer instructions stored thereon, as described in relation to FIG. 3 and FIG. 4. In some embodiments, the computer-readable medium may be a disc or a flash drive having the computer instructions stored thereon.

It will be apparent to those skilled in the art that various modifications and variations can be made to the disclosed data transferring system. Other embodiments will be apparent to those skilled in the art from consideration of the specification and practice of the disclosed data transferring system. It is intended that the specification and examples be considered as exemplary only, with a true scope being indicated by the following claims and their equivalents.

What is claimed is:

1. A control system for a vehicle for transferring data received from a communication device, the control system comprising:
at least one control interface configured to receive a first input from a vehicle occupant;
a display configured to generate an output visible to the vehicle occupant; and
a controller in communication with the communication device, the at least one control interface, the display, and the controller being configured to:
receive data from the communication device;
generate and output a query to the display based on the data;
receive the first input from the at least one control interface; and
output the data to the display based on the first input.

2. The control system of claim 1, wherein the controller is configured to receive a second input, and not output data associated with the second input based on the second input.

3. The control system of claim 2, wherein the controller is configured to delete the data associated with the second input from the controller based on the second input.

4. The control system of claim 3, wherein the controller is configured to initiate deletion of data associated with the second input from the communication device from which the data was received.

5. The control system of claim 1, wherein the display includes a head-up display.

6. The control system of claim 1, wherein the query relates to at least one of a source of the data, a type of the data, and a portion of the data.

7. The control system of claim 1, wherein the data includes turn-by-turn directions.

8. The control system of claim 1, wherein the controller is configured to automatically receive data from the communication device when the communication device is connected to a local network.

9. The control system of claim 8, wherein the controller is configured to automatically receive data that is sent to the communication device when the communication device is connected to the local network.

10. A method of transferring data from a communication device to a vehicle, the method comprising:
receiving data from the communication device;
generating and outputting a query to a display based on the data;
receiving a first input from at least one control interface; and
outputting the data to the display based on the first input.

11. The method of claim 10, further including:
receiving a second set of data from the communication device;
generating and outputting a query to the display based on the second set of data;
receiving a second input from the at least one control interface; and
not outputting the second set of data to the display based on the second input.

12. The method of claim 11, further including deleting the second set of data from the controller based on the second input.

13. The method of claim 12, further including initiating the deletion of the second set of data from the communication device from which the data was received.

14. The method of claim 10, wherein the outputting the query includes projecting the query on a windshield of the vehicle.

15. The method of claim 10, wherein the outputting the query includes outputting at least one of a source of the data, a type of the data, and a portion of the data.

16. The method of claim 10, wherein the outputting the data includes outputting turn-by-turn directions.

17. The method of claim 10, wherein the receiving data includes automatically receiving data from the communication device when the communication device is connected to a local network.

18. The method of claim 17, wherein the receiving data further includes automatically receiving data that is sent to the communication device when the communication device is connected to the local network.

19. A vehicle operated by a driver comprising:
a control system for processing data from a communication device to the vehicle, the control system comprising:
at least one control interface configured to receive at least a first input from the driver;
a display configured to generate an output visible to a vehicle occupant; and
a controller in communication with the communication device, the at least one control interface, the display, and the controller being configured to:
receive data from the communication device;
generate and output a query to the display based on the data;
receive the first input from the at least one control interface; and
output the data to the display based on the first input.

20. A non-transitory computer-readable medium storing instructions which, when executed, cause one or more processors to perform a method of transferring data from a communication device to a vehicle, the method comprising:
receiving data from the communication device;
generating and outputting a query to the display based on the data;
receiving a first input from the at least one control interface; and
outputting the data to the display based on the first input.
